(19) United States
(12) Patent Application Publication
(10) Pub. No.: US 2025/0189918 A1
(43) Pub. Date: Jun. 12, 2025

(54) IMAGE FORMING APPARATUS

(71) Applicant: CANON KABUSHIKI KAISHA, Tokyo (JP)

(72) Inventors: Shuichi Tetsuno, Kanagawa (JP); Shinsuke Kobayashi, Kanagawa (JP); Kazuhiro Funatani, Kanagawa (JP); Toshihiko Takayama, Kanagawa (JP); Jun Hara, Kanagawa (JP)

(21) Appl. No.: 19/060,441

(22) Filed: Feb. 21, 2025

Related U.S. Application Data
(63) Continuation of application No. 17/673,643, filed on Feb. 16, 2022.

(30) Foreign Application Priority Data
Feb. 24, 2021 (JP) 2021-027929

(51) Int. Cl. G03G 15/00; G03G 15/02; G03G 21/00

(52) U.S. Cl. CPC G03G 15/5037; G03G 15/0225; G03G 21/0005; G03G 21/0064

(57) ABSTRACT

An image forming apparatus includes an image bearing member, a charging member, a development member, a transfer member, a charging voltage application unit, a development voltage application unit, and a control unit. The development member collects toner that remains on a surface of the image bearing member after a toner image is transferred from the image bearing member surface to transfer material. The control unit controls application of a development voltage to apply, to the development member in a cleaning operation, a development voltage having a polarity that is opposite to a normal polarity, and controls application of a charging voltage to apply, to the charging member, a charging voltage having the normal polarity such that a potential difference formed at a charging portion between the applied charging voltage and a surface potential formed at the image bearing member surface is lower than or equal to a discharge start voltage.

### CROSS REFERENCE OF RELATED APPLICATIONS

This application is a continuation of U.S. patent application Ser. No. 17/673,643, filed on Feb. 16, 2022, which claims the benefit of Japanese Patent Application No. 2021-027929, filed on Feb. 24, 2021, which are hereby incorporated by reference herein in their entirety.

### BACKGROUND

### Field

The present disclosure relates to an image forming apparatus using, for example, an electrophotographic process.

### Description of the Related Art

Japanese Patent Application Laid-Open No. 2-272589 discusses an image forming apparatus using a drum cleanerless method as a method for an electrophotographic image forming apparatus such as a copying machine or a laser printer. In the drum cleanerless method, a photosensitive drum is not provided with a dedicated toner cleaning device.

In the image forming apparatus using the drum cleanerless method, a development unit is also used as a collection unit that collects residual toner remaining on the photosensitive drum after transferring. The residual toner collected by the development unit is reused in toner image development. Thus, a dedicated toner cleaning unit and a container for storing the collected residual toner are unnecessary. This makes it possible to reduce size and cost of the image forming apparatus.

However, the disclosure of Japanese Patent Application Laid-Open No. 2-272589 has an issue described below. In the drum cleanerless method, in a case where a great amount of residual toner remains on the photosensitive drum, the toner may adhere to a charging member that charges the photosensitive drum. This causes a failure of charging from the charging member to the photosensitive drum, and it becomes difficult to control a potential difference formed between a surface potential formed at a surface of the photosensitive drum and a development member to have a desired value. This sometimes results in a failure of residual toner collection by the development unit or an unintended image defect due to toner development by the development unit.

### SUMMARY

The present disclosure is directed to preventing a failure of charging of a surface of a photosensitive drum that is caused by toner adhered on a charging member and suitably collecting residual toner by a development unit.

According to an aspect of the present disclosure, an image forming apparatus includes an image bearing member configured to be rotatable, a charging member configured to come into contact with the image bearing member to form a charging portion and charge a surface of the image bearing member at the charging portion, a development member configured to be rotatable and to come into contact with the image bearing member to form a development portion and develop a toner image at the development portion by supplying a toner charged to a normal polarity to the surface of the image bearing member, a transfer member configured to form a transfer portion opposed to the image bearing member and transfer the toner image from the image bearing member to a transfer material at the transfer portion, a charging voltage application unit configured to apply a charging voltage to the charging member, a development voltage application unit configured to apply a development voltage to the development member, and a control unit configured to control the charging voltage application unit and the development voltage application unit, wherein the development member collects toner that remains on the surface of the image bearing member after the toner image formed on the surface of the image bearing member at the transfer portion is transferred from the transfer portion to the transfer material, wherein the control unit controls to perform an image forming operation of forming the toner image on the transfer material and a cleaning operation of cleaning a surface of the charging member in a state where the image bearing member, the charging member, and the development member are rotated, and wherein the control unit controls application of the development voltage to apply, to the development member in the cleaning operation, a development voltage having a polarity that is opposite to the normal polarity, and controls application of the charging voltage to apply, to the charging member, a charging voltage having the normal polarity such that a potential difference formed at the charging portion between the applied charging voltage and a surface potential formed at the surface of the image bearing member is lower than or equal to a discharge start voltage.

Further features of the present disclosure will become apparent from the following description of exemplary embodiments with reference to the attached drawings.

### BRIEF DESCRIPTION OF THE DRAWINGS

FIG. 1 illustrates an image forming apparatus according to a first exemplary embodiment.

FIGS. 2A and 2B illustrates a schematic diagram of a brush member according to the first exemplary embodiment.

FIG. 3 illustrates a control block diagram according to the first exemplary embodiment.

FIG. 4 illustrates a potential relationship at a development portion according to the first exemplary embodiment.

FIG. 5 illustrates a charging failure caused by a toner smear on a charging roller according to the first exemplary embodiment.

FIG. 6 illustrates a charging failure caused by a toner smear on a charging roller according to the first exemplary embodiment.

FIG. 7 illustrates an operation of cleaning a toner smear on the charging roller according to the first exemplary embodiment.

FIG. 8 illustrates an image forming apparatus according to a third exemplary embodiment.

### DESCRIPTION OF THE EMBODIMENTS

Various exemplary embodiments of the present disclosure will be describe in detail below with reference to the drawings. It should be noted that dimensions, materials, shapes, and relative positions of components described below are to be changed as needed based on a structure or various conditions of an apparatus to which the present disclosure is applied. In other words, the exemplary embodiments described below are not intended to limit the scope of the present disclosure.

### 1. Image Forming Apparatus

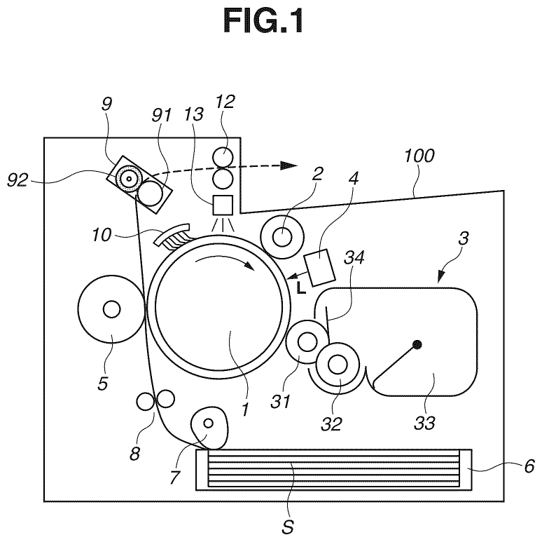

FIG. 1 illustrates a schematic structure of an image forming apparatus 100 according to an exemplary embodiment of the present disclosure.

The image forming apparatus 100 according to a first exemplary embodiment is a monochrome laser beam printer that employs a cleanerless method and a contact charging method.

The image forming apparatus 100 according to the first exemplary embodiment includes a photosensitive drum 1, which is a cylindrical photosensitive member, as an image bearing member. A charging roller 2 as a charging unit and a development device 3 as a development unit are arranged around the photosensitive drum 1. An exposure device 4 as an exposure unit is arranged between the charging roller 2 and the development device 3 in a rotation direction of the photosensitive drum 1 illustrated in FIG. 1. A transfer roller 5 as a transfer unit is in pressure contact with the photosensitive drum 1.

The photosensitive drum 1 according to the first exemplary embodiment is an organic photosensitive member having negative chargeability. The photosensitive drum 1 includes a photosensitive layer on a drum-shaped aluminum substrate and is driven and rotated at a predetermined process speed in a direction (clockwise direction) specified by an arrow in FIG. 1 by a driving motor as a driving unit. According to the first exemplary embodiment, the process speed corresponds to a circumferential speed (surface moving speed) of the photosensitive drum 1 and is 140 mm/sec, and an outer diameter of the photosensitive drum 1 is 24 mm.

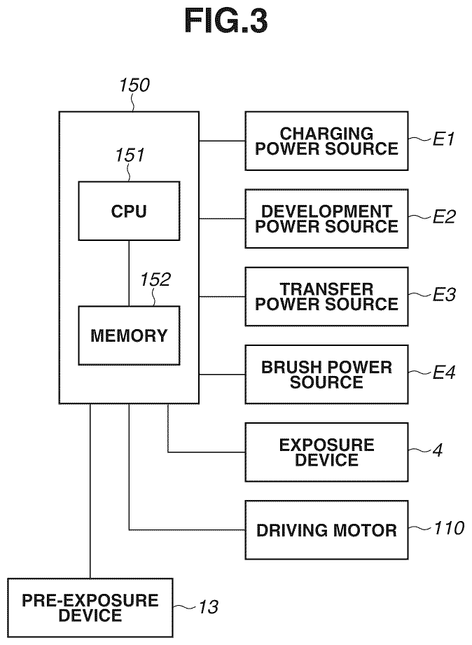

The charging roller 2 as a charging member is in contact with the photosensitive drum 1 at a predetermined pressure contact force to form a charging unit. Further, a charging high-voltage power source E1 (FIG. 3) as a charging voltage application unit applies a predetermined charging voltage to the charging roller 2, and the charging roller 2 uniformly charges a surface of the photosensitive drum 1 to a predetermined potential. According to the first exemplary embodiment, the surface of the photosensitive drum 1 is charged to have negative polarity by the charging roller 2. During charging processing, the charging power source E1 applies the predetermined charging voltage (charging bias) to the charging roller 2. According to the first exemplary embodiment, a negative-polarity direct current voltage as the charging voltage is applied to the charging roller 2 during charging processing. According to the first exemplary embodiment, the charging voltage is, for example, −1300 V (volts). Thus, according to the first exemplary embodiment, the surface of the photosensitive drum 1 is uniformly charged to a dark area potential Vd of −700 V. More specifically, the charging roller 2 charges the surface of the photosensitive drum 1 by an electrical discharge occurring in at least one of small spaces between the charging roller 2 and the photosensitive drum 1 that are respectively formed upstream and downstream of a contact portion of the charging roller 2 and the photosensitive drum 1 in the rotation direction of the photosensitive drum 1. However, in the present embodiment, the contact portion of the charging roller 2 and the photosensitive drum 1 in the rotation direction of the photosensitive drum 1 will be described as a charging portion.

The exposure device 4 as an exposure unit according to the first exemplary embodiment is a laser scanner device that outputs laser light corresponding to image information input from an external apparatus, such as a host computer, and scans and exposes the surface of the photosensitive drum 1. By performing the exposure, an electrostatic latent image (electrostatic image) based on the image information is formed on the surface of the photosensitive drum 1. According to the first exemplary embodiment, the exposure by the exposure device 4 decreases the absolute value of the dark area potential Vd of the surface of the photosensitive drum 1 that is formed by uniformly charging processing, and the dark area potential Vd becomes a light area potential V1 of −100 V. In the present embodiment, a position on the photosensitive drum 1 that is exposed by the exposure device 4 in the rotation direction of the photosensitive drum 1 is referred to as an exposure portion (exposure position). The exposure device 4 is not limited to a laser scanner device and can be, for example, a light emitting diode (LED) array including a plurality of LEDs arranged along a lengthwise direction of the photosensitive drum 1.

According to the first exemplary embodiment, a contact development method is used as a development method. The development device 3 includes a development roller 31 as a development member and a developer bearing member, a toner supplying roller 32 as a developer supplying member, a toner storage chamber 33 storing toner, and a development blade 34. The toner supplied from the toner storage chamber 33 to the development roller 31 by the toner supplying roller 32 passes through a blade nip, and thereby the toner is charged to a predetermined polarity. The blade nip is a contact portion of the development roller 31 and the development blade 34. The toner borne on the development roller 31 is moved from the development roller 31 to the photosensitive drum 1 at a development portion based on an electrostatic image. In the present specification, a contact portion of the development roller 31 and the photosensitive drum 1 in the rotation direction of the photosensitive drum 1 is the development portion. According to the first exemplary embodiment, the development roller 31 is driven and rotated anticlockwise to move the photosensitive drum 1 and the development roller 31 in a forward direction at the contact portion of the photosensitive drum 1 and the development roller 31. A driving motor as the driving unit that drives the development roller 31 can be a main motor used also as the driving unit of the photosensitive drum 1, or separate driving motors can respectively rotate the photosensitive drum 1 and the development roller 31. During development, a development power source E2 (FIG. 3) as a development voltage application unit applies a predetermined development voltage (development bias) to the development roller 31. According to the first exemplary embodiment, a negative-polarity direct current voltage as the development voltage is applied to the development roller 31 during development, and the development voltage is −380 V. According to the first exemplary embodiment, the toner charged to have the same polarity (negative polarity according to the first exemplary embodiment) as a charging polarity of the photosensitive drum 1 adheres to an exposed surface (image portion), which is an image forming portion on the photosensitive drum 1 having the decreased absolute value of the potential as a result of being exposed after the uniformly charging processing. This development method is referred to as a reversal development method. According to the first exemplary embodiment, a normal polarity, which is a charging polarity of the toner during development, is the negative polarity. While a single-component non-magnetic contact development method is employed according to the first exemplary embodiment, the present disclosure is not limited to this form. A two-component non-magnetic contact development method, a non-contact development method, or a magnetic development method can be employed. The two-component non-magnetic contact development method is a method in which a two-component developer containing a non-magnetic toner and a magnetic carrier is used as a developer and the developer borne on a developer bearing member is brought into contact with the photosensitive drum 1 to perform development. The non-contact development method is a method in which a toner is moved through the air from a developer bearing member arranged to face a photosensitive member contactlessly onto the photosensitive member to perform development. The magnetic development method is also a method in which a magnetic toner is borne on a developer bearing member by magnetic force to perform development. The developer bearing member is arranged to face a photosensitive member either in contact with or without contact with the photosensitive member, and a magnet as a magnetic field generation unit is contained in the developer bearing member. According to the first exemplary embodiment, a toner having an average particle diameter of 6 μm (micro-meters) and having negative polarity as normal charging polarity is used.

The transfer roller 5 is suitably used as a transfer member that consists of an elastic member, such as a sponge rubber made of polyurethane rubber, ethylene propylene diene monomer (EPDM) rubber, or nitrile-butadiene (NBR) rubber. The transfer roller 5 is pressed against the photosensitive drum 1 to form a transfer portion where the photosensitive drum 1 and the transfer roller 5 are in pressure contact with each other. During transfer, a transfer power source E3 (FIG. 3), which is a transfer voltage application unit, applies a predetermined transfer voltage (transfer bias) to the transfer roller 5. According to the first exemplary embodiment, a direct current voltage having an opposite polarity (positive polarity according to the first exemplary embodiment) to the normal polarity of the toner is applied as the transfer voltage to the transfer roller 5 during transfer. According to the first exemplary embodiment, the transfer voltage during transfer is, for example, +1000 V.

A toner image is then electrostatically transferred from the photosensitive drum 1 to a recording material S by an effect of an electric field formed between the transfer roller 5 and the photosensitive drum 1.

A transfer material S as a recording material stored in a cassette 6 is fed by a sheet feeding unit 7 and conveyed through a registration roller pair 8 to the transfer portion in synchronization with a timing when the toner image formed on the photosensitive drum 1 reaches the transfer portion. The toner image formed on the photosensitive drum 1 is transferred onto the transfer material S by the transfer roller 5 to which the predetermined transfer voltage is applied by the high-voltage transfer power source E3.

The transfer material S with the toner image transferred thereto is conveyed to a fixing device 9. The fixing device 9 is a fixing device that uses a film heating method, and the fixing device 9 includes a fixing film 91 and a pressing roller 92. The fixing film 91 includes therein a fixing heater (not illustrated) and a thermistor (not illustrated) that measures the temperature of the fixing heater. The pressing roller 92 is in pressure contact with the fixing film 91. The transfer material S is then heated and pressed to fix the toner image to the transfer material S, and the resulting transfer material S is conveyed through a sheet discharge roller pair 12 to the outside of the image forming apparatus 100.

Further, the toner that is not transferred to the transfer material S and remains as residual toner on the photosensitive drum 1 is removed by a process described below.

The residual toner contains a mixture of the toner that is charged to the positive polarity and the toner that is charged to the negative polarity not having enough charges. The residual toner is charged to the negative polarity again by a discharge at the charging portion by the charging roller 2. The residual toner charged to the negative polarity again by the charging roller 2 is conveyed to the development portion by the rotation of the photosensitive drum 1. There is a case where an electrostatic latent image is formed to form an image forming portion on the surface of the photosensitive drum 1 that has reached the development portion, and there is a case where a non-image forming portion where no electrostatic latent image is formed is formed. A behavior of the residual toner that reaches the development portion will now be described. The residual toner on the image forming portion of the photosensitive drum 1 and the residual toner on the non-image forming portion of the photosensitive drum 1 will be described separately.

The residual toner adhered on the image forming portion of the photosensitive drum 1 is not transferred from the photosensitive drum 1 to the development roller 31 at the development portion but moved to the transfer portion together with the developed toner from the development roller 31 and transferred to the transfer material S to be used in image forming.

In contrast, the residual toner adhered on the non-image forming portion of the photosensitive drum 1 is charged to the negative polarity, which is the normal polarity, again at the charging portion, is transferred to the development roller 31 at the development portion by a potential difference between a potential of the non-image forming portion of the photosensitive drum 1 and the development voltage, and is collected into the toner storage chamber 33. The toner collected into the toner storage chamber 33 is used again in image forming.

A pre-exposure device 13 is provided as a device for removing the charging potential of the photosensitive drum 1 between the transfer portion and the charging portion in the rotation direction of the photosensitive drum 1. This is to reduce the nonuniformity of the surface potential of the photosensitive drum 1 that is caused by the transfer so that the discharge at the charging portion is stabilized and a uniform charging potential is obtained.

### 2. Structure of Brush Member

Next, a paper dust removing mechanism according to the first exemplary embodiment will now be described. As illustrated in FIG. 1, the image forming apparatus 100 according to the first exemplary embodiment includes a brush member 10 (collecting member). The brush member 10 is a contact member as a paper dust removing mechanism. According to the first exemplary embodiment, the image forming apparatus 100 includes the brush member 10. The brush member 10 comes into contact with the surface of the photosensitive drum 1 downstream of the transfer portion and upstream of the charging portion in the rotation direction of the photosensitive drum 1, and forms a brush contact portion (brush contact position). In the present embodiment, a contact portion of the brush member 10 and the photosensitive drum 1 in the rotation direction of the photosensitive drum 1 is referred to as the brush contact portion.

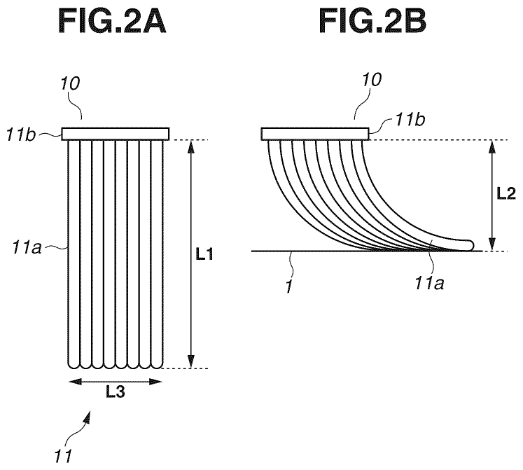

FIG. 2A illustrates the brush member 10 alone viewed along a lengthwise direction of the brush member 10. The lengthwise direction is substantially parallel to a rotational axis direction of the photosensitive drum 1. FIG. 2B illustrates the brush member 10 in contact with the photosensitive drum 1 viewed along the lengthwise direction of the brush member 10.

A brush portion of the brush member 10 consists of a fixed brush 11 fixed at a particular position and having conductivity. As illustrated in FIGS. 2A and 2B, the brush member 10 includes a pile yarn (conductive yarn) 11a and a base cloth 11b supporting the pile yarn 11a. The pile yarn 11a is a plurality of hair materials for rubbing the surface of the photosensitive drum 1 and is made of conductive nylon 6. As described above, the brush member 10 is arranged to come into contact with the photosensitive drum 1 downstream of the transfer portion and upstream of the charging portion in a movement direction (rotation direction) of the photosensitive drum 1.

The brush member 10 is arranged such that a lengthwise direction of the brush member 10 is substantially parallel to the rotational axis direction of the photosensitive drum 1. According to the first exemplary embodiment, the fixed brush 11 consists of the conductive yarn 11a made from a nylon fiber containing a conductive substance and the base cloth 11b made from a synthetic fiber containing carbon as a conducting agent, and the conductive yarn 11a is woven in the base cloth 11b. The conductive yarn 11a may be made from a material other than nylon, such as rayon, acryl, or polyester.

As illustrated in FIG. 2A, a distance L1 is the distance from the base cloth 11b to a distal end of the conductive yarn 11a that is exposed in a state where the brush member 10 is alone, i.e., a state where no external force to bend the conductive yarn 11a is applied. According to the first exemplary embodiment, the distance L1 is 6.5 mm. The base cloth 11b of the brush member 10 is fixed to a support member (not illustrated) arranged at a predetermined position in the image forming apparatus 100 with a fixing device such as a double-sided tape, and the distal end of the conductive yarn 11a is arranged to intrude on the photosensitive drum 1. According to the first exemplary embodiment, a clearance between the support member and the photosensitive drum 1 is fixed. The shortest distance from the base cloth 11b of the brush member 10 fixed to the support member to the photosensitive drum 1 is a distance L2. According to the first exemplary embodiment, the difference between the distance L2 and the distance L1 is defined as an amount of intrusion of the brush member 10 on the photosensitive drum 1. According to the first exemplary embodiment, the amount of intrusion of the brush member 10 on the photosensitive drum 1 is 1 mm. According to the first exemplary embodiment, as illustrated in FIG. 2A, a length L3 of the brush member 10 in a circumferential direction (hereinafter, referred to as “widthwise direction”) of the photosensitive drum 1 in a state where the brush member 10 is alone is 5 mm. Further, according to the first exemplary embodiment, the length of the brush member 10 in the lengthwise direction is 216 mm. The brush member 10 can thereby come into contact with an entire image forming region (region where a toner image can be formed) on the photosensitive drum 1 in the rotational axis direction of the photosensitive drum 1. According to the first exemplary embodiment, the conductive yarn 11a has a thickness of two deniers and a density of 240 kF/inch². Here, “kF/inch²” is a unit of brush density and specifies the number of filaments per square inch. As described above, the brush member 10 is supported by the support member (not illustrated) and arranged at a fixed position in the photosensitive drum 1, and the brush member 10 rubs the surface of the photosensitive drum 1 as the photosensitive drum 1 moves.

The brush member 10 captures (collects) adhesions, such as paper dust, transferred from the recording material S onto the photosensitive drum 1 at the transfer portion. The brush member 10 reduces the amount of paper dust moving to the charging portion downstream of the brush member 10 in the movement direction of the photosensitive drum 1 and to the development portion.

The length L3 of the brush member 10 in the widthwise direction of the photosensitive drum 1 is set to 5 mm according to the first exemplary embodiment. However, the length L3 is not limited to this. For example, the length L3 can be changed as needed based on a life of the image forming apparatus 100 or a process cartridge. The longer the brush member 10 in the widthwise direction, the longer period of time the brush member 10 can capture paper dust.

The length of the brush member 10 in the lengthwise direction is set to 216 mm according to the first exemplary embodiment. However, the length is not limited to that specified above, and the length can be changed as needed based on, for example, a maximum sheet-passing width of the image forming apparatus 100.

While the fineness of the brush member 10 according to the first exemplary embodiment is 220T/96F (indicating 96 bundled threads each having a thickness of 220 grams per 10000 meters), and the fineness is preferably determined considering a slip-through characteristics of paper dust. The brush member 10 with low fineness does not have enough power to block paper dust, and paper dust easily slips through the brush member 10. This may prevent a charging of the photosensitive drum 1 caused by the charging roller 2, and lead to an image defect. In contrast, the brush member 10 with high fineness cannot collect toner and fine paper dust. Thus, an image defect may occur due to an uneven density caused by a nonuniform transfer of toner along a longer side of the charging roller 2 or a charging failure at a position of paper dust adhesion portion.

The density of the brush member 10 according to the first exemplary embodiment is 240 kF/inch² (kF/inch² is a unit of brush density specifying the number of filaments per square inch), and the density is preferably determined considering a pass-through characteristics of toner and a paper dust collection characteristics. Specifically, in a case where the density of the brush member 10 is high, the pass-through characteristics of toner decreases, and this may cause a defect. Specifically, the toner can be stuck, and the stuck toner can be splattered to make a mess in the image forming apparatus 100. Further, in a case where the density of the brush member 10 is low, the power of collecting paper dust decreases. Thus, the thickness of the conductive yarn 11a is preferably one to six deniers and 150 to 350 kF/inch², and the density of the conductive yarn 11a is preferably 150 to 350 kF/inch², from the point of view of the paper dust collection characteristics. The length of the brush member 10 in the widthwise direction is preferably three mm or longer from the view point of long life.

A brush power source E4 (FIG. 3) as a brush voltage application unit is connected to the brush member 10. During image forming, the brush power source E4 applies a predetermined brush voltage (brush bias) to the brush member 10. According to the first exemplary embodiment, a negative-polarity direct current voltage as the brush voltage is applied to the brush member 10 during image forming. According to the first exemplary embodiment, the brush voltage during image forming is, for example, −350 V.

### 3. Image Output Operation

According to the first exemplary embodiment, the image forming apparatus 100 performs an image output operation (job). The image output operation is a series of operations of forming an image on a single or a plurality of recording materials S based on a single start instruction from an external device (not illustrated) such as a personal computer. The job generally includes an image forming process (printing process), a pre-rotation process, a sheet spacing process in the case of forming an image on a plurality of recording materials S, and a post-rotation process. The image forming process is a process of, for example, forming an electrostatic image on the photosensitive drum 1, developing the electrostatic image (forming a toner image), transferring the toner image, and fixing the toner image. The term “timing for the image forming” refers to a period for performing the image forming process. More specifically, timings for the image forming differ depending on a position where the electrostatic image forming, the toner image forming, the toner image transferring, or the toner image fixing is performed. The pre-rotation process is a period for performing a preparation operation before the image forming process. The sheet spacing process is a process performed in a period corresponding to an interval between recording materials S when the image forming apparatus 100 continuously performs the image forming process on the plurality of recording materials S (timing for continuous image forming). The post-rotation process is a process for performing an organizing operation (preparation operation) after the image forming process. The term “timing for non-image forming” refers to a period other than the timing for image forming. Examples of the timing for non-image forming include a period of, for example, the pre-rotation process, the sheet spacing process, the post-rotation process, and a multiple pre-rotation process. The multiple pre-rotation process is a preparation operation performed when the image forming apparatus 100 is turned on or when the image forming apparatus 100 returns from a sleep state.

### 4. Form of Control

FIG. 3 is a schematic block diagram illustrating a form of control of a major part of the image forming apparatus 100 according to the first exemplary embodiment. The image forming apparatus 100 includes a control unit 150. The control unit 150 includes a central processing unit (CPU) 151, a memory (storage element) 152, and an input/output unit (not illustrated). The CPU 151 is a central element as a calculation control unit that performs calculation processing. The memory 152 is a storage unit such as a read-only memory (ROM) and a random access memory (RAM). The input/output unit controls signal transmission and reception to and from various elements connected to the control unit 150. The RAM stores sensor detection results and calculation results. The ROM stores, for example, control programs and a pre-required data table.

The control unit 150 is a control unit that comprehensively controls operations of the image forming apparatus 100. The control unit 150 controls transmission and reception of various electric information signals and driving timings and performs a predetermined image forming sequence. The components of the image forming apparatus 100 are connected to the control unit 150. For example, the charging power source E1, the development power source E2, the transfer power source E3, the brush power source E4, the driving motor 110, and the pre-exposure device 13 are connected to the control unit 150 in relation to the first exemplary embodiment.

### 5. Residual Toner Processing Process

Next, steps of processing the toner that is not used in image forming, such as the residual toner remaining on the photosensitive drum 1 after transferring, will now be described.

The residual toner remaining on the photosensitive drum 1 contains a mixture of the toner charged to the positive polarity opposite to the normal polarity of the toner and the toner charged to the negative polarity but not having sufficient charges. These toners are sufficiently charged to the negative polarity by a discharge caused by a potential difference formed between the charging roller 2 and the photosensitive drum 1 immediately before the charging portion as the contact portion of the charging roller 2 and the photosensitive drum 1. As a result, an electrostatically repulsive force against the charging roller 2 to which the negative-polarity charging voltage is applied is obtained, and thereby the toner passes through the charging portion without adhering to the charging roller 2. Further, some part of the toner that has not been sufficiently charged to the negative polarity by the discharge at the charging portion once adheres to the charging roller 2. However, the toner is charged to the negative polarity again at the charging portion by a rub between the charging roller 2 and the photosensitive drum 1 and application of the charging voltage, and the charged toner is moved from the charging roller 2 to the photosensitive drum 1 by an electrostatically repulsive force against the charging roller 2 to which the negative-polarity charging voltage is applied.

After being charged to the negative polarity at the charging portion, the residual toner on the photosensitive drum 1 is moved to the development portion by the rotation of the photosensitive drum 1 and is then processed as follows.

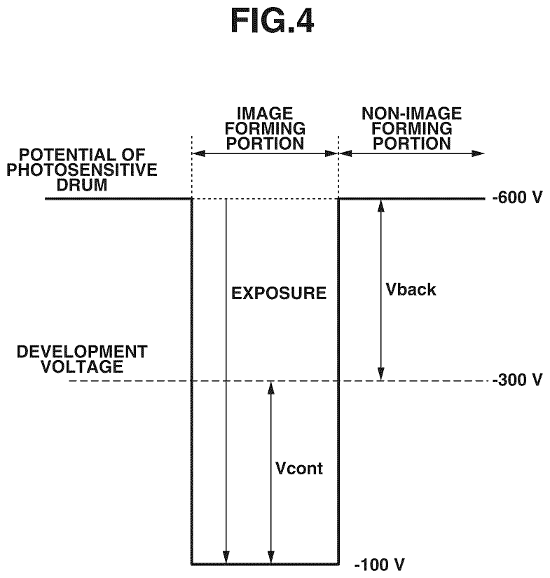

FIG. 4 illustrates a relationship between the surface potential formed on the photosensitive drum 1 and the development voltage at the development portion according to the first exemplary embodiment. As illustrated in FIG. 4, at the non-image forming portion where an electrostatic latent image is not formed at the development portion, the development voltage is relatively closer to positive-polarity values than the surface potential of the photosensitive drum 1 charged by the charging roller 2 is. Thus, the residual toner on the photosensitive drum 1 charged to the negative polarity is moved from the photosensitive drum 1 to the development roller 31 and is then collected into the toner storage chamber 33 due to the above-described potential relationship.

The potential difference, which is a back contrast (Vback), between the surface potential of the photosensitive drum 1 and the development voltage in the non-image forming portion illustrated in FIG. 4 is preferably set as described below. In order to collect the toner on the photosensitive drum 1 that is charged to the negative polarity onto the development roller 31, the back contrast Vback at the development portion is set to a sufficient value. Furthermore, the back contrast Vback is preferably set to a value to prevent unintended development of the toner, i.e., fog toner described below, borne on the development roller 31 to the surface of the photosensitive drum 1. Specifically, the back contrast Vback is preferably set to about 100 V to about 500 V. In a case where the back contrast Vback is lower than or equal to 100 V, it is difficult to ensure that the toner charged to the negative polarity and attached to the surface of the photosensitive drum 1 is collected. Furthermore, unintended development of the toner charged to the negative polarity on the development roller 31 to the photosensitive drum 1, i.e., fog toner, is likely to occur. In contrast, in a case where the back contrast Vback is higher than 500 V, since the back contrast Vback is excessively high, the toner on the development roller 31 is charged toward the positive polarity by a discharge generated between the development roller 31 and the photosensitive drum 1. Thus, the fog toner occurring from the development roller 31 to the photosensitive drum 1 is likely to occur. According to the first exemplary embodiment, the surface potential Vd of the photosensitive drum 1 is set to −600 V, the development voltage is set to −300 V, and the back contrast Vback is set to 300 V.

Further, as illustrated in FIG. 4, a development contrast (Vcont) is formed at the image forming portion where an electrostatic latent image is formed at the development portion. The development contrast (Vcont) is a potential relationship that develops the toner charged to the negative polarity from the development roller 31 to the photosensitive drum 1. Thus, the toner on the photosensitive drum 1 that is charged to the negative polarity is directly used as a toner image and, furthermore, the development of the toner from the development roller 31 forms a toner image, and the toner image is moved to the transfer portion and then transferred to the transfer material S.

In a case where a great amount of residual toner remains on the photosensitive drum 1 after the transferring, however, it is difficult to sufficiently charge the residual toner on the photosensitive drum 1 to the negative polarity at the charging portion. Thus, the toner charged to the positive polarity may adhere to the charging roller 2 to accumulate a toner smear on the charging roller 2.

Examples of a case where a great amount of residual toner remains on the photosensitive drum 1 after the transferring especially include a case where the following condition is satisfied: when printing is performed under a hot and humid environment, when printing is performed after a new toner is supplied to the toner storage chamber 33 as in a third exemplary embodiment, when printing is performed on a sheet (talc sheet) containing a great amount of talc as a loading material, when printing is performed with the image forming apparatus 100 close to an end of the life, or when a jam occurs. In the above-described case, a great amount of toner smear may be generated due to the toner with decreased chargeability. This may cause accumulation of the toner smear on the charging roller 2.

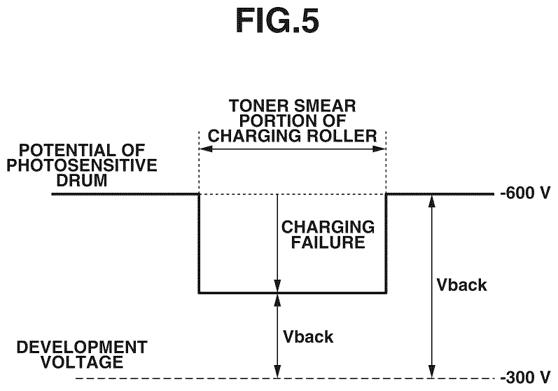

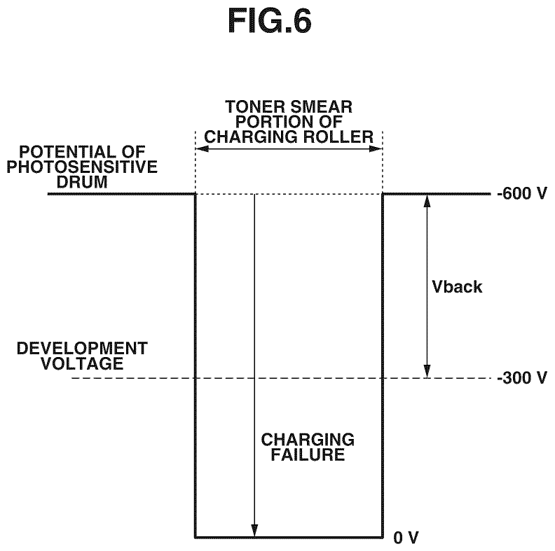

As illustrated in FIG. 5, in a case where a great amount of toner is accumulated on the charging roller 2, the charging roller 2 fails to charge the photosensitive drum 1 at a toner smear portion of the charging roller 2, and the back contrast Vback decreases. The charging failure occurs because the toner on the surface of the charging roller 2 increases the resistance to make it difficult to perform an intended discharge. Especially in a case where the back contrast Vback becomes lower than 100 V, as described above, the residual toner charged to the negative polarity on the photosensitive drum 1 is not successfully collected by the development roller 31 at the non-image forming portion of the development portion. Furthermore, the fog toner may occur on the photosensitive drum 1. The residual toner on the photosensitive drum 1 that has not been developed or collected or the fog toner adhere to the charging roller 2 as a toner smear, and this promotes a charging failure. The amount of discharge at the charging portion then decreases due to the toner smear on the charging roller 2, and this decreases the absolute value of the surface potential of the photosensitive drum 1. As the amount of discharge decreases, the back contrast Vback decreases, so that the amount of fog toner increases. As a result, charging of the photosensitive drum 1 eventually becomes substantially impossible at the toner smear portion of the charging roller 2 as illustrated in FIG. 6. Furthermore, part of the toner developed to an unsuccessfully-charged portion of the photosensitive drum 1 due to the toner smear on the charging roller 2 is transferred to the recording material S to cause an image defect due to the toner smear.

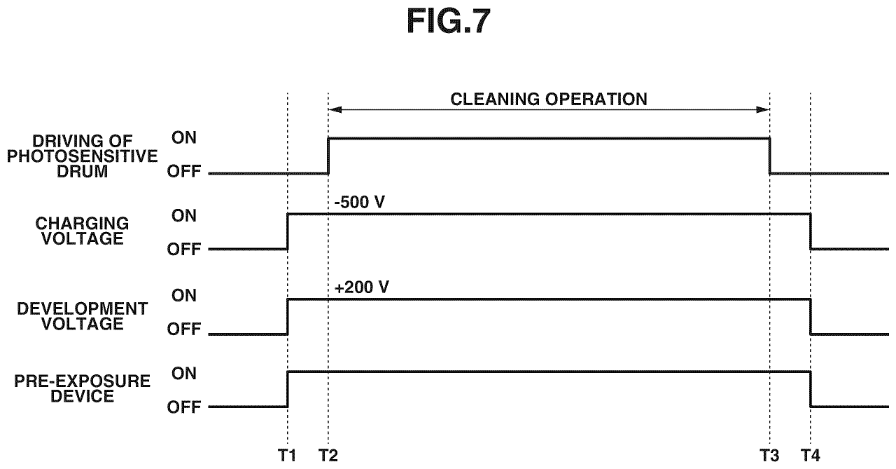

The image forming apparatus 100 according to the first exemplary embodiment therefore includes a cleaning operation on the charging roller 2 as described below. FIG. 7 illustrates a timing chart of the cleaning operation according to the first exemplary embodiment. A trigger to perform the cleaning operation can be a selection of a mode by a user or a detection of a use situation where the amount of residual toner on the photosensitive drum 1 after the transferring is expected to be great.

At a timing T1, the charging voltage and the development voltage are applied, and the pre-exposure device 13 is turned on. According to the first exemplary embodiment, various voltages are applied before the photosensitive drum 1 is driven. According to the first exemplary embodiment, the charging voltage is set to −500 V, and the development voltage is set to +200 V. The charging voltage is a voltage lower than or equal to a discharge start voltage. According to the first exemplary embodiment, the discharge start voltage is set to −550 V. The charging voltage and the development voltage are applied so that the potential difference used for the cleaning operation is formed between the photosensitive drum 1 and the brush member 10 and between the photosensitive drum 1 and the development roller 31 at the contact portion and the development portion. After the charging voltage and the development voltage rise sufficiently, the driving of the photosensitive drum 1 is started at a timing T2. The charging voltage is thereby applied, and the toner discharged to the surface of the photosensitive drum 1 having the potential difference formed at the charging portion is suitably collected at the development portion. At a timing T3 after the cleaning operation is performed for a desired period of time, the driving of the photosensitive drum 1 is first turned off. Thereafter, at a timing T4, the charging voltage, the development voltage, and the exposure of the pre-exposure device 13 are turned off at substantially the same time. From the timing T2 to the timing T3, the cleaning operation on the charging roller 2 is performed, and according to the first exemplary embodiment, the time period from the timing T2 at which the driving motor 110 is turned on to the timing T3 at which the driving motor 110 is turned off is set to correspond to one rotation of the photosensitive drum 1. During the cleaning operation, the development roller 31 and the charging roller 2 are in contact with the photosensitive drum 1. Further, the timings T3 and T4 can be the same.

According to the first exemplary embodiment, the charging voltage, the development voltage, and the pre-exposure device 13 are uniformly turned on at the same timing. Although the charging voltage and the development voltage are to be applied before the driving of the driving motor 110, the timing of exposure by the pre-exposure device 13 can be controlled. Specifically, the exposure can be started at a timing when the surface of the photosensitive drum 1, which forms the development portion in a state where the driving of the photosensitive drum 1 is stopped, reaches an opposed surface of the pre-exposure device 13, i.e., a pre-exposure portion where the surface of the photosensitive drum 1 is exposed. Further, the exposure can be started at a timing when the surface of the photosensitive drum 1 that forms the charging portion reaches the pre-exposure portion where the surface of the photosensitive drum 1 is exposed.

The cleaning operation is preferably performed at least for a length of time corresponding to one rotation of the charging roller 2 and a movement of the surface of the photosensitive drum 1, which forms the charging portion, to the development portion during the one rotation. This is because the rotation needs to be performed long enough to clean the entire perimeter of the charging roller 2 and to collect the toner discharged from the charging roller 2 to the surface of the photosensitive drum 1 at the development portion. The length of the cleaning operation can obviously be set longer than that specified above. According to the first exemplary embodiment, the length of the cleaning operation is set to correspond to one rotation of the photosensitive drum 1.

An effect of the cleaning operation on the charging roller 2 according to the first exemplary embodiment will now be described.

Since the development voltage has positive polarity, the back contrast Vback is formed as appropriate even in a case where the charging of the photosensitive drum 1 fails due to the toner smear on the charging roller 2. It is thus possible to prevent a failure of collection of the residual toner on the photosensitive drum 1 at the development portion due to a charging failure and generation of fog toner.

If the charging roller 2 and the photosensitive drum 1 are driven and rotated in a state where the negative-polarity charging voltage is applied, the toner adhered on the charging roller 2 is thereby charged to the negative polarity, and the charged toner moves from the charging roller 2 to the photosensitive drum 1 caused by an electrostatically repulsive force against the charging roller 2.

In order to obtain the electrostatically repulsive force between the charging roller 2 and the toner charged to the negative polarity, the charging voltage is to be greater toward the negative polarity than the surface potential of the photosensitive drum 1 at the charging portion.

In a case where the charging voltage is excessively greater toward the negative polarity than the surface potential of the photosensitive drum 1, however, the amount of discharge between the charging roller 2 and the photosensitive drum 1 increases immediately before the charging portion of the charging roller 2 and the photosensitive drum 1. This may promote the charging of the toner adhered on the charging roller 2 to the positive polarity and make it difficult to charge the toner adhered on the charging roller 2 to the negative polarity.

Specifically, the charging voltage during performance of the cleaning operation is set to be greater toward the negative polarity than the surface potential of the photosensitive drum 1 at the charging portion. Furthermore, the potential difference between the charging voltage during performance of the cleaning operation and the surface potential of the photosensitive drum 1 at the charging portion is set to be greater than or equal to the development contrast Vcont in the image forming operation. Furthermore, the charging voltage lower than or equal to the discharge start voltage is set to be applied to be lower than or equal to a discharge threshold value of the discharge between the charging roller 2 and the photosensitive drum 1. This produces both an effect of moving the toner charged to the negative polarity on the charging roller 2 to the photosensitive drum 1 and an effect of charging the toner on the charging roller 2 to the negative polarity. By controlling the potential difference at the charging portion to be greater than the development contrast Vcont set to enable development, the performance of toner discharge from the charging roller 2 is improved. In other words, forming the potential difference greater than or equal to the development contrast Vcont at the charging portion moves the electrically sufficient toner to the surface of the photosensitive drum 1.

According to the first exemplary embodiment, the pre-exposure device 13 removes static electricity from the photosensitive drum 1 during the cleaning operation on the charging roller 2, so that a history of the surface potential of the photosensitive drum 1 before performance of the cleaning operation is erased and the charging potential of the photosensitive drum 1 is set to substantially zero V. This facilitates control of the potential difference between the charging voltage and the surface potential of the photosensitive drum 1.

The toner charged to the negative polarity and moved from the charging roller 2 to the photosensitive drum 1 is then moved to the development roller 31 and collected into the toner storage chamber 33 at the development portion where the back contrast Vback is formed as appropriate, whereby the toner adhered on the charging roller 2 is removed.

### 6. Effect of First Exemplary Embodiment

Next, a method of checking an effect of the cleaning operation on the toner smear on the charging roller 2 according to the first exemplary embodiment will now be described.

Two-page printing was repeatedly performed using the image forming apparatus 100 according to the first exemplary embodiment in a hot and humid environment at a temperature of 32.5 degrees Celsius and a humidity of 90%. The image forming apparatus 100 was in a new state, the toner storage chamber 33 stored 50 grams of toner, and an image had a text image pattern with a printing ratio of 5%.

A talc sheet was employed as a recording material S, and a Century Star sheet (product name, manufactured by Century Pulp And Paper) was used. In a first comparative example and a first example, the presence/absence of an image defect on a printed recording material S and the state of a toner smear on the charging roller 2 were checked every predetermined number of sheets. In the first comparative example, the cleaning operation for the toner smear on the charging roller 2 was not performed. In the first example, the cleaning operation on the toner smear on the charging roller 2 was performed every 250 sheets.

TABLE 1

| | | | First Example | |
|---|---|---|---|---|
| Cumulative | First Comparative Example | | | Toner |
| Number of | | Toner Smear | | Smear on |
| Printed | Image | on Charging | Image | Charging |
| Sheets | Defect | Roller 2 | Defect | Roller 2 |
| 250 | None | None | None | None |
| 500 | None | Light Smear | None | None |
| 750 | Light Toner | Smear | None | None |
| | Smear | | | |
| 1000 | Thick Toner | Great Amount | None | Light Smear |
| | Smear | of Smear | | |
| 1200 | Toner Smear | Great Amount of | None | Light Smear |
| | throughout | Smear throughout | | |
| | Sheet | Sheet | | |

In the first comparative example as specified in Table 1, a toner smear started occurring at both edges of the charging roller 2 when the cumulative number of printed sheets reached 500. When the cumulative number of printed sheets reached 750, image defects due to the toner smears occurred on the sheet at positions corresponding to the toner smear positions at the edges of the charging roller 2. The printing operation was continued thereafter, and when the cumulative number of printed sheets reached 1200, image defects occurred throughout the sheet due to the toner smears on the sheet as a result of the toner smears on the charging roller 2.

On the contrary, with the structure according to the first example, smears on the charging roller 2 worsened slightly but no image defects occurred during printing of 1200 sheets. This indicates that performing the cleaning operation regularly on the charging roller 2 successfully moved the toner on the charging roller 2 to the photosensitive drum 1. There are cases where a toner smear on the charging roller 2 is developed little by little although the cleaning operation is performed regularly, so that the number of times or the length of time of sequence execution can be increased as the cumulative number of printed sheets increases as described in a second exemplary embodiment.

Further, a change in the state of the toner smear on the charging roller 2 when the cleaning operation on the charging roller 2 according to the first exemplary embodiment was performed once from the time point when the cumulative number of printed sheets reached 1200 in the state of the first comparative example was also checked. Each time the cleaning operation was performed, the toner smears on the charging roller 2 became slight, and when the cleaning operation was performed five times, the toner smear on the charging roller 2 was removed substantially completely. From the foregoing results, it can be said that performing the cleaning operation corresponding to five rotations of the photosensitive drum 1 successfully removed the toner on the charging roller 2 even in a case where the charging roller 2 was in a state of causing image defects.

From the above-described results, the structure according to the first example is as described below.

The rotatable photosensitive drum 1 and the charging roller 2 are included. The charging roller 2 is brought into contact with the photosensitive drum 1 to form the charging portion and charges the surface of the photosensitive drum 1 at the charging portion. Further, the rotatable development roller 31 is included. The rotatable development roller 31 is brought into contact with the photosensitive drum 1 to form the development portion and develops a toner image by supplying the toner charged to the normal polarity to the surface of the photosensitive drum 1 at the development portion. Further, the transfer roller 5 is included. The transfer roller 5 forms the transfer portion opposed to the photosensitive drum 1 and transfers the toner image from the photosensitive drum 1 to the recording material S as a transfer material at the transfer portion. Further, a charging voltage application unit E1, a development voltage application unit E2, and the control unit 150 are included. The charging voltage application unit E1 applies the charging voltage to the charging roller 2, and the development voltage application unit E2 applies the development voltage to the development roller 31. The control unit 150 controls the charging voltage application unit E1 and the development voltage application unit E2.

According to the structure, the toner image formed on the surface of the photosensitive drum 1 is transferred to the recording material S at the transfer portion, and thereafter the residual toner remaining on the surface of the photosensitive drum 1 is collected by the development roller 31. The image forming operation of forming a toner image on a recording material S and the cleaning operation of cleaning the surface of the charging roller 2 are performed in a state where the photosensitive drum 1, the charging roller 2, and the development roller 31 are rotated.

The control unit 150 controls application of the development voltage to apply the development voltage having the opposite polarity to the normal polarity to the development roller 31 at the development portion in the cleaning operation. Further, the control unit 150 controls application of the charging voltage having the normal polarity so that the potential difference between the charging voltage and the surface potential formed at the photosensitive drum 1 is lower than or equal to the discharge start voltage at the charging portion. Furthermore, the control unit 150 performs control such that the potential difference between the charging voltage formed at the charging portion and the surface potential formed at the photosensitive drum 1 in the cleaning operation is greater than the potential difference between the development voltage formed at the development portion and the surface potential formed at the photosensitive drum 1 in image forming operation. Furthermore, static electricity is removed from the surface of the photosensitive drum 1 downstream of the transfer portion and upstream of the charging portion in the rotation direction of the photosensitive drum 1 during the cleaning operation. The pre-exposure device 13 as a static electricity removing member is used for removing the static electricity from the surface of the photosensitive drum 1.

The photosensitive drum 1 is preferably driven and rotated such that the length of the movement of the surface of the photosensitive drum 1 in the cleaning operation is longer than the total value of the length corresponding to one rotation of the charging roller 2 and the length from the charging portion to the development portion in the rotation direction of the photosensitive drum 1.

As described above, performing the cleaning operation on the charging roller 2 according to the first exemplary embodiment produces the following advantages. Failure of charging of the photosensitive drum 1 by the charging roller 2 due to a great amount of toner adhered on the charging roller 2 is prevented. Furthermore, a failure of collection of the residual toner on the photosensitive drum 1 at the development portion due to a charging failure and generation of fog toner are prevented.

While the above-described structure according to the first exemplary embodiment includes the pre-exposure device 13, the pre-exposure device 13 may not be included. The static electricity can be removed from the surface potential of the photosensitive drum 1 not by the pre-exposure device 13 but by exposure by the exposure device 4 or by applying a positive-polarity voltage to the transfer roller 5 during performance of the cleaning operation on the toner smear on the charging roller 2.

Further, the charging roller 2 can be driven and rotated according to the first exemplary embodiment. The charging roller 2 is driven and rotated to have a difference in circumferential speed from the photosensitive drum 1 so that the toner on the surface of the charging roller 2 is easily be charged to the normal polarity. The movement speed of the surface of the charging roller 2 is preferably 95% to 105% when the movement speed of the surface of the photosensitive drum 1 is 100%.

According to the first exemplary embodiment, a sheet member as a rubbing member in contact with the surface of the charging roller 2 can be provided. The sheet member and the toner on the surface of the charging roller 2 rub each other, so that the toner is easily charged to the normal polarity.

Next, a second exemplary embodiment as another exemplary embodiment of the present disclosure will be described. Configurations and operations of an image forming apparatus according to the present exemplary embodiment are basically the same as those of the image forming apparatus 100 according to the first exemplary embodiment. Thus, each component of the image forming apparatus 100 according to the present exemplary embodiment having the same or corresponding function or configuration as or to a component of the image forming apparatus 100 according to the first exemplary embodiment is given the same reference numeral as that of the image forming apparatus 100 according to the first exemplary embodiment, and thus redundant descriptions thereof are omitted.

### 1. Cleaning Operation According to Second Exemplary Embodiment

In a second example, as specified in Table 2, the cleaning operation was set to be performed more frequently as the cumulative number of printed sheets of the image forming apparatus 100 increased. The cleaning operation was controlled to be performed during the post-rotation operation performed after the completion of the image forming operation, and a frequency of performance of the cleaning operation was changed for each cumulative number of printed sheets. The rest of the configuration is similar to that of the first example, and therefore redundant descriptions thereof are omitted.

TABLE 2

| | Timing of | Interval from |
|---|---|---|
| | Execution of | Previous Execution |
| | Cleaning | of Cleaning |
| | Operation | Operation |
| Cumulative | 250 | — |
| Number of | 500 | 250 |
| Printed Sheets | 750 | 250 |
| | 1000 | 250 |
| | 1200 | 200 |
| | 1400 | 200 |
| | 1600 | 200 |
| | 1800 | 200 |
| | 2000 | 200 |
| | 2100 | 100 |
| | 2200 | 100 |
| | 2300 | 100 |
| | 2350 | 50 |
| | 2400 | 50 |
| | 2450 | 50 |
| | 2500 | 50 |

Performing the cleaning operation more frequently as the cumulative number of printed sheets of the image forming apparatus 100 increases prevents an increase in reversed toner smears caused by talc accumulation in the toner storage chamber 33 as a result of an increased cumulative number of printed sheets using talc sheets. Further, the frequency of performance of the cleaning operation is optimized based on an increase in reversed toner smears caused by toner degradations in a development container as a result of an increased cumulative number of printed sheets.

### 2. Effect of Second Exemplary Embodiment

A method of checking an effect of the cleaning operation on the toner smear on the charging roller 2 according to the second exemplary embodiment will now be described.

Two-page printing was repeatedly performed using the image forming apparatus 100 according to the second exemplary embodiment in a hot and humid environment at a temperature of 32.5 degrees Celsius and a humidity of 90% to obtain 2500 printed sheets in total. The image forming apparatus 100 was in a new state, the development container stored 50 grams of toner, and an image used a text image pattern with a printing ratio of 5%. A talc sheet was employed as a recording material S, and a Century Star sheet was used. The presence of an image defect on a printed recording material S and the state of a toner smear on the charging roller 2 were checked every predetermined number of sheets.

As a result of checking an effect, toner smears on the charging roller 2 and image defects on printed sheets were not detected when the cumulative number of printed sheets was 2500 in the image forming apparatus 100 according to the second exemplary embodiment.

As described above, the cleaning operation on the charging roller 2 is performed based on a status of smears caused by the reversed toner charged to the positive polarity, which is the opposite polarity, so that toner smears on the charging roller 2 are reduced without excessively performing the cleaning operation.

Further, while the cleaning operation is performed more frequently as the cumulative number of printed sheets of the image forming apparatus 100 increases according to the second exemplary embodiment, the length of time of the cleaning operation can be increased while the frequency remains the same. Furthermore, it is also possible to employ a suitable combination of frequency and time in performing the cleaning operation.

Next, the third exemplary embodiment as another exemplary embodiment according to the present disclosure will now be described. Configurations and operations of an image forming apparatus according to the present exemplary embodiment are basically the same as those of the image forming apparatus 100 according to the first exemplary embodiment. Thus, each component of the image forming apparatus according to the present exemplary embodiment that has the same or corresponding function or configuration as or to a component of the image forming apparatus 100 according to the first exemplary embodiment is given the same reference numeral as that of the image forming apparatus 100 according to the first exemplary embodiment, and redundant descriptions thereof are omitted.

### 1. Image Forming Apparatus

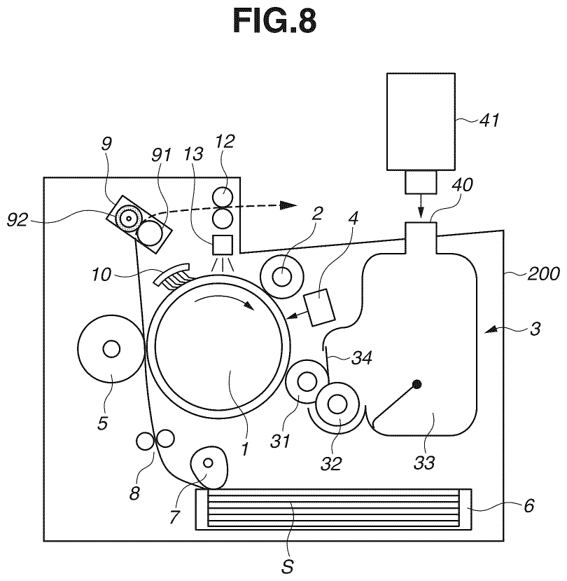

According to the third exemplary embodiment, as illustrated in FIG. 8, an image forming apparatus 200 includes a toner supply mechanism 40 for the toner storage chamber 33. With the toner supply mechanism 40, new toner is supplied into the toner storage chamber 33 at desired timings. A toner pack 41 is mounted on the toner supply mechanism 40. The toner pack 41 is a toner supply container that is attachable to and detachable from the image forming apparatus 200. While the toner pack 41 is mounted on the image forming apparatus 200 according to the third exemplary embodiment, the toner pack 41 can be mounted directly on the toner storage chamber 33 as a development container. Further, the toner supply container is not limited to the toner pack 41. The toner supply container can have a toner bottle shape, and employ any shape or structure as long as toner can be supplied directly to the toner supply container.

According to the present exemplary embodiment, a method (direct supply method) in which a user supplies toner from the toner pack 41 storing toner for supply is employed. Thus, an operation of replacing the toner storage chamber 33 as a development container is unnecessary when the toner level of the toner storage chamber 33 is low, so that usability increases. The image forming apparatus 200 and the toner pack 41 form an image forming system.

However, an issue described below arises in a case where the printing operation with the image forming apparatus 200 is performed a certain number of times and new toner is to be supplied. In a case where new toner is supplied into the toner storage chamber 33 while the toner in the toner storage chamber 33 is degraded, the degraded toner and the new toner rub each other in the toner storage chamber 33, and the new toner having higher charging capability is often charged toward the normal polarity of the toner. Specifically, the degraded toner having low charging capability and stored in advance in the toner storage chamber 33 is likely to be charged toward the polarity opposite to the polarity of the toner. Thus, in supplying the new toner into the toner storage chamber 33, a great amount of reversed toner smears caused by the degraded toner charged to the opposite polarity may be generated. This often occurs especially in a case where a great amount of new toner is supplied at once when the toner level in the toner storage chamber 33 becomes low as described in the third exemplary embodiment. In other words, the issue is not a major issue for a configuration in which new toner is constantly supplied to the toner storage chamber 33 to maintain a predetermined toner level as the stored toner is consumed.

In a case where the image forming apparatus 200 performs printing after new toner is supplied into the toner storage chamber 33, reversed toner smears caused by the degraded toner as a result of the toner supply tend to decrease gradually as the new supplied toner degrades. Thus, it can be said that reversed toner smears are most likely to occur immediately after toner is supplied and that reversed toner smears caused by the toner supply are likely to occur therefrom for a certain period of time.

### 2. Cleaning Operation According to Third Exemplary Embodiment

Details of the cleaning operation in the image forming apparatus 200 according to the third exemplary embodiment are similar to those in the first exemplary embodiment. The cleaning operation is controlled to be performed during the post-rotation operation performed after the completion of the image forming operation, and the frequency of performance is changed for each cumulative number of printed sheets as in the second exemplary embodiment. As specified in Table 3, the cleaning operation is frequently performed during a predetermined period after the toner is supplied into the toner storage chamber 33. After the predetermined period passes, it was set such that the cumulative number of printed sheets of the image forming apparatus 200 is to increase and the frequency of performance of the cleaning operation is to decrease.

Thereafter, in a case where the cumulative number of printed sheets of the image forming apparatus 200 further decreases, the control as in the second exemplary embodiment was performed. Specifically, the frequency of performance of the cleaning operation is set to increase as the cumulative number of printed sheets increases to adjust to an increase in reversed toner smears caused by talc accumulation in the toner storage chamber 33 or an increase in reversed toner smears caused by the degraded toner in the toner storage chamber 33.

The cleaning operation on the toner smears on the charging roller 2 from the state where the image forming apparatus 200 is new to the time when the toner is supplied is set to the frequency of performance specified in Table 2 similarly to the second exemplary embodiment.

TABLE 3

| | Timing of | Interval from |
|---|---|---|
| | Execution of | Previous Execution |
| | Cleaning | of Cleaning |
| | Operation | Operation |
| Cumulative | 0 | — |
| Number of | 10 | 10 |
| Printed Sheets | 30 | 20 |
| after Toner | 60 | 30 |
| Supply | 120 | 60 |
| | 250 | 130 |
| | 500 | 250 |
| | 750 | 250 |
| | 1000 | 250 |
| | 1200 | 200 |
| | 1400 | 200 |
| | 1600 | 200 |
| | 1800 | 200 |
| | 2000 | 200 |
| | 2100 | 100 |
| | 2200 | 100 |
| | 2300 | 100 |

As specified in Table 3, according to the third exemplary embodiment, the cleaning operation is frequently performed in a state where the degraded toner causes a great amount of reversed toner smears immediately after the toner is supplied. As printing is performed a number of times after the toner is supplied and as the reversed toner smears caused by the toner supply decreases, the frequency of performance of the cleaning operation is decreased. This makes it possible to minimize the frequency of performance of the cleaning operation to adjust to the transition of the reversed toner smears caused by the toner supply while the toner smears on the charging roller 2 are prevented. According to the third exemplary embodiment, the cleaning operation is also controlled to be performed immediately after the toner is supplied, because reversed toner smears are most likely to occur immediately after the toner is supplied.

### 3. Effect of Third Exemplary Embodiment

Two-page printing was repeatedly performed using the image forming apparatus 200 according to the third exemplary embodiment in a hot and humid environment at a temperature of 32.5 degrees Celsius and a humidity of 90% to obtain 2500 printed sheets in total. Thereafter, the toner supply mechanism 40 supplied 35 grams of new toner into the development container, and two-page printing was repeatedly performed again to obtain 2500 printed sheets in total after the toner supply. The image forming apparatus 200 was in a new state, the toner storage chamber 33 stored 50 grams of toner, and an image used a text image pattern with a printing ratio of 5%. A talc sheet was employed as a recording material S, and a Century Star sheet was used.

The presence/absence of an image defect on a printed recording material S and the state of a toner smear on the charging roller 2 were checked every predetermined number of sheets.

As a result of checking an effect, toner smears on the charging roller 2 and image defects on printed sheets due to the toner smears were not detected in the printing of 2500 sheets after the supply of toner to the image forming apparatus 200.

As described above, the cleaning operation on the charging roller 2 is performed based on a status of reversed toner smears caused by the toner supply, so that toner smears on the charging roller 2 and image defects caused by the toner smears are reduced.

As described above, according to the present disclosure, a failure of charging of a surface of a photosensitive drum that is caused by toner on a charging member is prevented, and a development unit suitably collects residual toner.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An image forming apparatus comprising:
a photosensitive drum configured to be rotatable;
a charging roller configured to come into contact with the photosensitive drum to form a charging portion and charge a surface of the photosensitive drum at the charging portion;
a development roller configured to be rotatable and to come into contact with the photosensitive drum to form a development portion and develop a toner image at the development portion by supplying a toner charged to a normal polarity as a negative polarity to the surface of the photosensitive drum;
a transfer roller configured to form a transfer portion opposed to the photosensitive drum and transfer the toner image from the photosensitive drum to a transfer material at the transfer portion;
a charging voltage power source configured to apply a charging voltage to the charging roller;
a development voltage power source configured to apply a development voltage to the development roller; and
a controller configured to control the charging voltage power source and the development voltage power source,
wherein the development roller collects the toner that remains on the surface of the photosensitive drum after the toner image formed on the surface of the photosensitive drum at the transfer portion is transferred from the transfer portion to the transfer material,
wherein the controller controls to perform an image forming operation of forming the toner image on the transfer material and a cleaning operation of cleaning a surface of the charging roller in a state where the photosensitive drum, the charging roller, and the development roller are rotated, and
wherein the controller controls application of the development voltage to apply, to the development roller in the cleaning operation, a development voltage having a positive polarity, and controls application of the charging voltage to apply, to the charging roller, a charging voltage having the negative polarity such that a potential difference formed at the charging portion between the applied charging voltage and a surface potential formed at the surface of the photosensitive drum is lower than or equal to a discharge start voltage and the potential difference is in a direction in which electrostatic force directed from the charging roller to the photosensitive drum acts on the toner charged to the negative polarity.

2. The image forming apparatus according to claim 1, wherein the controller performs control such that the potential difference formed at the charging portion in the cleaning operation is greater than a potential difference between the development voltage formed at the development portion and a surface potential formed at the surface of the photosensitive drum in the image forming operation.

3. The image forming apparatus according to claim 1, further comprising a pre-exposure device configured to remove static electricity from the surface of the photosensitive drum downstream of the transfer portion and upstream of the charging portion in a rotation direction of the photosensitive drum,
wherein the controller controls removal to remove the static electricity from the surface of the photosensitive drum in the cleaning operation.

4. The image forming apparatus according to claim 1, wherein the controller controls driving and rotation of the charging roller such that a surface moving speed of the photosensitive drum and a surface moving speed of the charging roller are different from each other in the cleaning operation.

5. The image forming apparatus according to claim 1, further comprising a transfer voltage power source configured to apply a transfer voltage to the transfer roller, wherein, in the cleaning operation, the controller controls application to the transfer roller of a transfer voltage having the positive polarity.

6. The image forming apparatus according to claim 1, wherein the controller controls the cleaning operation to perform the cleaning operation during a post-rotation operation performed after the image forming operation is completed.

7. The image forming apparatus according to claim 1, wherein the controller controls driving and rotation of the photosensitive drum such that a length of a surface movement of the photosensitive drum in the cleaning operation is longer than a total value of a length corresponding to one rotation of the charging roller and a length from the charging portion to the development portion in a rotation direction of the photosensitive drum.

8. The image forming apparatus according to claim 1, wherein the toner supplied to the surface of the photosensitive drum is a single-component developer.

9. The image forming apparatus according to claim 1, further comprising:
a brush configured to form a contact portion downstream of the transfer portion and upstream of the charging portion in a rotation direction of the photosensitive drum and be in contact with the surface of the photosensitive drum at the contact portion,
wherein the brush has a base fabric and a yarn portion including a plurality of yarns extending from the base fabric, and a density of the plurality of yarns of the brush is 150 to 350 kF/inch².
